(19) United States
(12) Patent Application Publication
(10) Pub. No.: US 2025/0176476 A1
(43) Pub. Date: Jun. 5, 2025

(54) PLANTER TRAY WITH WATERING ACCESS

(71) Applicant: MG Tools LLC, Vista, CA (US)

(72) Inventor: Adam Footer, Vista, CA (US)

(21) Appl. No.: 18/524,357

(22) Filed: Nov. 30, 2023

(51) Int. Cl. A01G 9/029

(52) U.S. Cl. CPC A01G 9/0293

(57) ABSTRACT

A planter tray apparatus including a bottom wall extending along a plane. A side wall extends transversely to the plane and from the bottom wall. A concavity is formed in the side wall and in the bottom wall. The concavity is a discontinuity in the side wall that extends from an area between an upper perimeter through the plane along which the bottom wall extends. The concavity is formed by a convex wall extending between an inner surface of the bottom wall and an inner surface of the side wall. The concavity has a profile of a geometrical shape.

### BACKGROUND

Plants are grown in a variety of ways. A convenient method for preparing seedlings prior to planting or for growing as a microgreen crop for personal or private use, for example, is to use a conventional planter tray system designed to support many seedlings growing quickly by sitting nested in a conventional non-draining tray. The configuration of the conventional tray. However, planter trays suffer from drawbacks in that they can be difficult to adequately supply water to the non-draining tray due the overlapping arrangement.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

FIG. 1 is a top, front, left-side perspective view of an embodiment of a planter tray;

FIG. 2 is a bottom, back, right-side perspective view of the embodiment of the planter tray of FIG. 1;

FIG. 3 is a top view of the embodiment of the planter tray of FIG. 1;

FIG. 4 is a bottom view of the embodiment of the planter tray of FIG. 1; and

FIG. 5 is a left-side view of planter tray system implementing the planter tray of the embodiment of FIG. 1.

### DETAILED DESCRIPTION

### Overview

This disclosure is directed to embodiments of a planter tray (hereinafter “tray”) that include a watering access feature providing improved access to water seedlings (e.g., microgreens, wheatgrass, etc.) while minimizing water spillage/waste and. For the sake of convenience and consistency, a planter tray may be defined as having at least a bottom wall (e.g., base, floor, lower surface, etc.) intended for supporting matter (such as seedlings), and at least one side wall that protrudes from the respective outer borders of the bottom wall so as to form a shallow volume of space bounded by the upper surface of the bottom wall and between opposing inner-facing surfaces of the side wall. For the purposes of this disclosure, the term “shallow” is considered to convey that dimensions of the volume of space bounded by the planter tray walls indicates a shorter relative height of the volume (determined by the height of the side wall) compared to the largest lateral dimension of the volume (determined by the size and shape of the bottom wall). Note, though not shown, it is considered that trays may be circular, and thus may be considered to have a solitary, continuous wall. Though, the figures and the specification discusses rectangular trays (i.e., multiple side walls), it is contemplated that a circular tray (i.e. a single side wall), or other geometric shape, could be considered and include the watering access feature as described hereinafter.

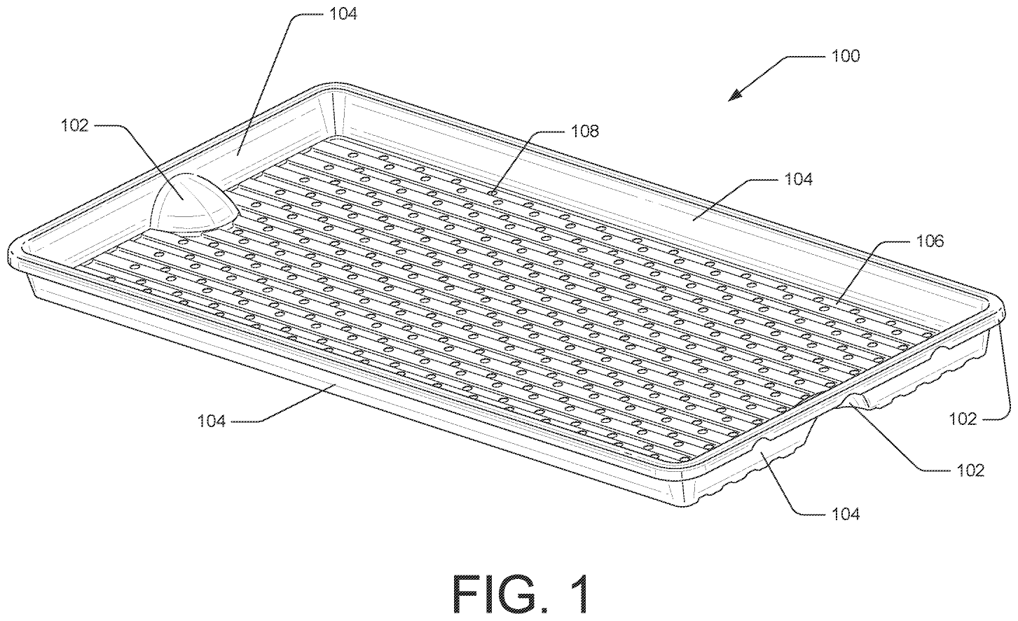

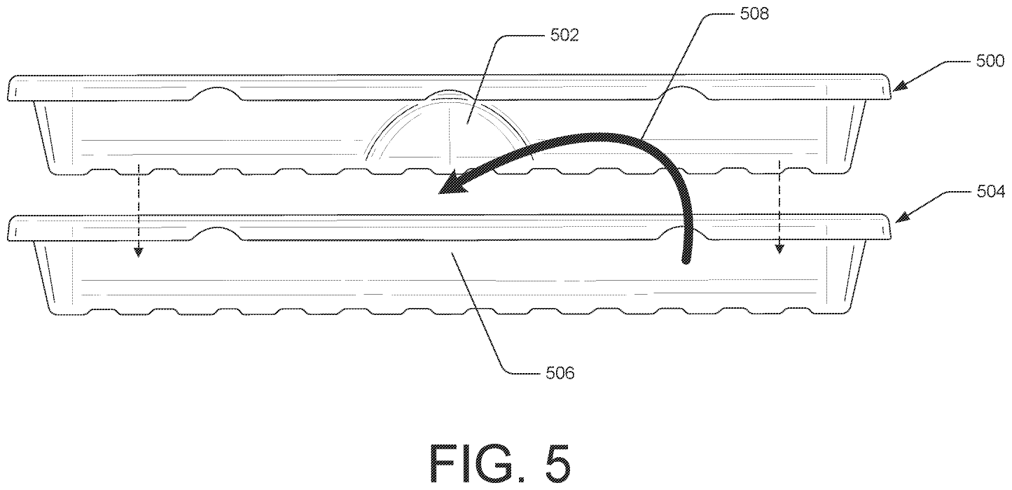

In an embodiment, the planter tray includes the aforementioned watering access feature disposed at one or more side walls of the planter tray. The watering access feature finds greater purpose when implemented in use, being paired with a non-draining lower tray. That is, the planter tray, (which generally includes water drainage holes), nests closely into the non-draining tray (see for example FIG. 5), meaning a tray without holes for drainage. Note, FIGS. 1-4 depict a planter tray with a single watering access feature on two opposing side ends, each being symmetrically aligned with respect to the geometrical shape of the planter tray, and with respect to each other. Alternatively, it is contemplated and considered within the scope of the disclosure that in an embodiment, a planter tray may have one or more (i.e., two or more) watering access features, and/or the watering access feature(s) may be positioned in a portion of the perimeter of the planter tray that is unsymmetrical with respect to the geometrical shape of the planter tray (i.e., the watering access feature may not fall on line of symmetry of the planter tray) or with respect to another watering access feature on the planter tray. However, for the sake of and convenience of standard and compact shipping and efficient manufacturing, the planter tray may be formed with watering access features that are aligned with each other and with respect to the lines of symmetry of the planter tray, as depicted.

Note, an additional benefit of the watering access features as depicted in FIGS. 1-5 is that they may serve also as ergonomically oriented and shaped for convenient lifting/carrying of the planter tray. In contrast, the conventional planter trays for microgreen growth do not include a watering feature, and as such, users generally must use additional time and physical effort to lift the planter tray to add water to the non-draining tray.

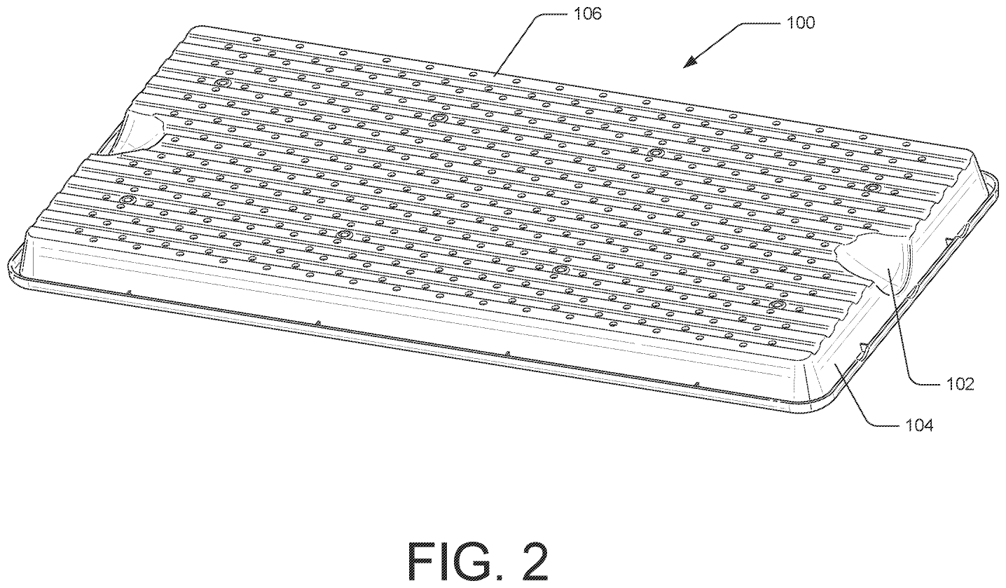

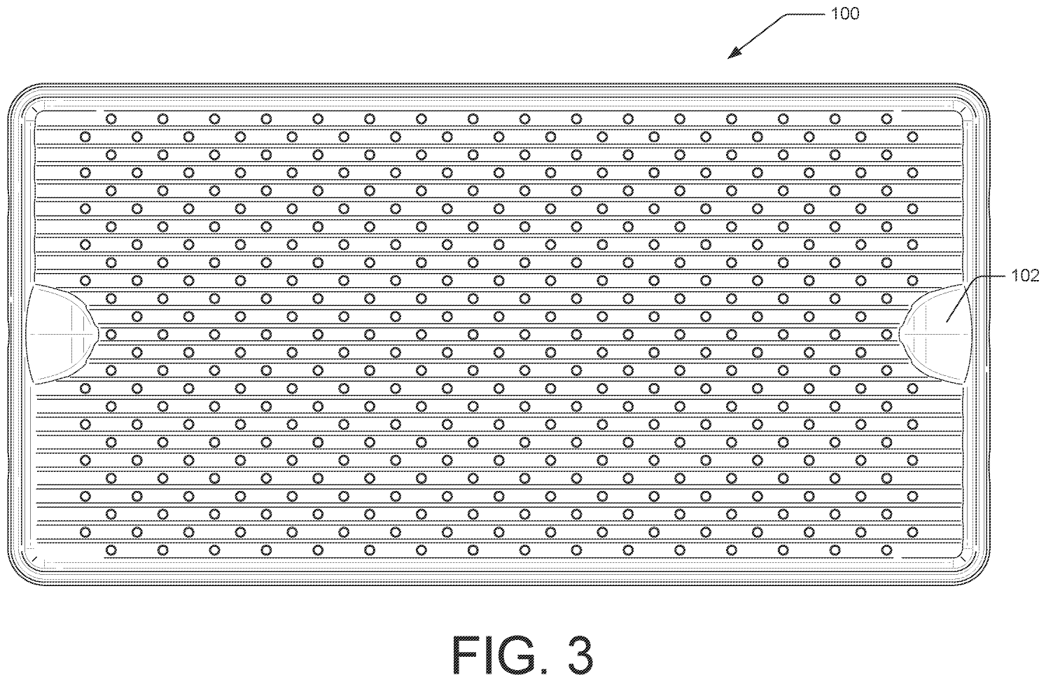

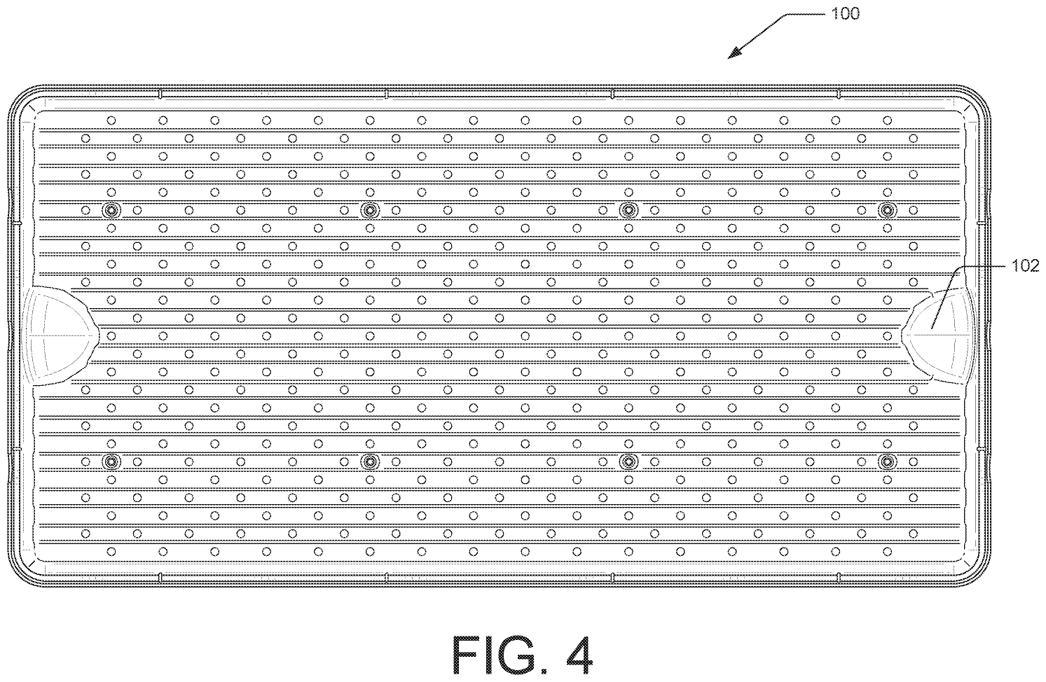

As depicted in FIG. 1, in an embodiment, a planter tray 100 may be formed with a watering access feature 102. The watering access feature 102 may be molded (or otherwise manufactured into the planter tray 100) as a recessed area in at least a portion of a side wall 104 (e.g., lateral wall support, transversely protruding from a perimeter of the bottom wall) of the planter tray 100 and at least a portion of the adjoining edge of the bottom wall 106 (e.g., base, lower support surface, tray bottom, etc.) of the planter tray 100. In an embodiment, the planter tray 100 may further include To be clear, when viewed from the bottom-looking view (i.e., see FIGS. 2 and 4, the outside-surface looking view) of the planter tray 100, the watering access feature 102 appears as a concave shape, where the perimeters of the concavity define a pocket recessed away from the surrounding exterior wall surfaces (bottom wall 106 and side wall(s) 104) and pushed toward the interior volumetric space of the planter tray 100. Conversely, when viewed from the top-looking view (i.e., see FIGS. 1 and 3, the inside-surface looking view) of the planter tray 100, the watering access feature 102 appears as a convex shape, where the perimeters of the convexity define a protrusion expanded upward away from the interior wall surfaces (bottom wall 106 and side wall(s) 104) and bulged toward the interior volumetric space of the planter tray 100.

Thus, a side wall 104, such as the side wall 104 depicted on the right end in FIG. 1, which has a watering access feature 102 therein, is discontinuous along the length of extension thereof, where the discontinuity (i.e., a gap in the wall) is due to the presence of the watering access feature 102. In other words, there is a gap in the plane of the side wall, at which the material of the planter tray 100 is formed into the concave wall shape of the watering access feature 102.

In an embodiment as shown, a profile shape of a wall surface (inner or outer) of the watering access feature 102 may be defined as a portion of a three-dimensional shape forming a concavity into a portion of the side wall 104 and the bottom wall 106. The complete three-dimensional shape from which the concavity of the watering access feature 102 is derived, may be spheroidal (having an arched surface), triangular, cuboidal, etc. In other words, the dimensions of the concavity may be determined to accommodate a size of the particular watering apparatus (not explicitly shown, though the arrow 508 in FIG. 5 may be representative of a watering apparatus) being used to water seedlings (not shown) that may have been placed in the planter tray 100. For example, the watering apparatus may include any of a hose, a tube, a watering can spout, a nozzle, etc.

In an embodiment, the bottom wall 106 may be corrugated (i.e., have an undulated surface of alternating projecting/recessing ribs). Additionally, the bottom wall 106 may further include pre-punched holes 108 through the surface to provide water drainage pathways. The pre-punched holes 108 may be placed anywhere in the bottom wall 106 as desired. For example, the pre-punched holes 108 may be formed in parallel lines as depicted, such as might be manufactured at a factory, and/or the pre-punched holes 108 may be punched by the user accordingly to particular desires. The number and size of pre-punched holes 108 may vary depending on desired usage.

Additionally, the side wall(s) 104 extend from the bottom wall 106, transversely with respect thereto, such that the side wall(s) 104 extend at an angle ranging between 0 and 90 degrees that facilitates stacking and nesting of the planter tray 100 within other trays (see FIG. 5). In an embodiment, the side wall(s) 104 may be perpendicular to the bottom wall 106. However, an angle of extension of the side wall(s) 104 having a slope that is non-perpendicular to the plane of the bottom wall 106 provides greater ease in the nesting arrangement. Furthermore, the side wall(s) 104 may have an overhanging lip or flange 110 that surrounds (either entirely or in part) an upper perimeter or edge of the protruding wall to structurally reinforce the rigidity of the side wall(s) 104. In an embodiment, the upper edge may be thicker than the wall below, forming a thicker lip, and/or the upper edge of the wall may be flared outward forming a flange as mentioned above.

Thus, in an embodiment shown in FIG. 5, a planter tray 500 (like planter tray 100) with a watering feature 502 (like watering feature 102) is shown in the pre-nesting arrangement in a vertical alignment with a non-draining tray 504 with a continuous side wall 506. The combination of the planter tray 500 with the non-draining tray 504 may be considered a planter tray system.

As indicated above, with a conventional planter tray, in this nested orientation, the continuous side wall 506 of the conventional tray would interfere with the watering apparatus. However, as disclosed and depicted in FIG. 5, the watering access feature 102 on the planter tray 500 provides a concavity through the bottom wall and the side wall whereby the watering apparatus may pass, to provide water to the non-draining tray. As such, plants in the planter tray 500 are able to be watered from below by drawing water via punched holes in the bottom wall of the planter tray 500. That is, the watering access feature 502 facilitates the passage of a watering apparatus (e.g., hose, tube, etc., see above) along a route similar to that denoted by the arrow 508 into the interior space of the non-draining tray 504. Accordingly, despite the second tray 500b being nested in close proximity and immediately below the planter tray 500, a watering apparatus may be inserted directly to the non-draining tray without requiring a user to lift the planter tray 500 or perform any additional steps.

### Conclusion

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

What is claimed is:

1. A planter tray apparatus comprising:
a base extending along a plane;
a first side wall portion extending transversely to the plane and from a first edge of the base, the first side wall portion extending to an upper perimeter of the planter tray;
a second side wall portion extending transversely to the plane from a second edge of the base, the second side wall portion extending to the upper perimeter;
a first gap in the first side wall portion that extends from an area between the upper perimeter through the plane along which the base extends, the first gap being formed by a first convex wall extending between an inner surface of the base and an inner surface of the first side wall portion; and
and a second gap in the second side wall portion that extends from an area between the upper perimeter through the plane along which the base extends, the second gap being formed by a second convex wall extending between the inner surface of the base and an inner surface of the second side wall portion.

2. The planter tray apparatus according to claim 1, wherein the base is corrugated.

3. The planter tray apparatus according to claim 1, wherein the base has pre-punched drain holes.

4. The planter tray apparatus according to claim 1, wherein the upper edge of the first wall side portion extends away from an interior of the planter tray, thereby forming a flange.

5. The planter tray apparatus according to claim 1, wherein the planter tray apparatus is stackable in a non-draining tray.

6. The planter tray apparatus according to claim 1, wherein the first side wall portion and the second side wall portion are continuous between the first gap and the second gap.

7. The planter tray apparatus according to claim 1, wherein a profile of the first gap and a profile of the second gap are defined as partially spheroidal.

8. A planter tray apparatus comprising:
a bottom wall extending along a plane;
a side wall extending transversely to the plane and from the bottom wall;
a concavity in the side wall and in the bottom wall, the concavity being a discontinuity in the side wall that extends from an area between an upper perimeter through the plane along which the bottom wall extends, the concavity being formed by a convex wall extending between an inner surface of the bottom wall and an inner surface of the side wall,
wherein the concavity has a profile of a geometrical shape.

9. The planter tray apparatus according to claim 8, wherein the geometrical shape is spheroidal.

10. The planter tray apparatus according to claim 8, wherein the geometrical shape is triangular.

11. The planter tray apparatus according to claim 8, wherein the geometrical shape is cuboidal.

12. The planter tray apparatus according to claim 8, further comprising a lip surrounding an upper edge of the side wall.

13. The planter tray apparatus according to claim 12, wherein lip of the is folded outward and returns downward at an end thereof.

14. A planter tray apparatus comprising:
a bottom wall extending along a plane;
a side wall extending transversely to the plane and from the bottom wall;
a concavity in the side wall and in the bottom wall, the concavity being a discontinuity in the side wall that extends from an area between an upper perimeter through the plane along which the bottom wall extends, the concavity being formed by a convex wall extending between an inner surface of the bottom wall and an inner surface of the side wall,
wherein the concavity is positioned symmetrically along a line of symmetry of the bottom wall.

15. The planter tray apparatus according to claim 14, wherein the concavity has a profile of a geometrical shape.

16. The planter tray apparatus according to claim 15, wherein the geometrical shape is spheroidal.

17. The planter tray apparatus according to claim 15, wherein the geometrical shape is triangular.

18. The planter tray apparatus according to claim 15, wherein the geometrical shape is cuboidal.

19. The planter tray apparatus according to claim 14, wherein the bottom wall has pre-punched drain holes.

20. The planter tray apparatus according to claim 14, wherein the bottom wall is corrugated.
